(19) United States
(12) Patent Application Publication
(10) Pub. No.: US 2018/0145311 A1
(43) Pub. Date: May 24, 2018

(54) METHOD OF PRODUCING SULFIDE SOLID ELECTROLYTE

(71) Applicant: TOYOTA JIDOSHA KABUSHIKI KAISHA, Toyota-shi (JP)

(72) Inventor: Takeshi TOJIGAMORI, Susono-shi (JP)

(73) Assignee: TOYOTA JIDOSHA KABUSHIKI KAISHA, Toyota-shi (JP)

(21) Appl. No.: 15/788,170

(22) Filed: Oct. 19, 2017

(30) Foreign Application Priority Data
Nov. 18, 2016 (JP) 2016-225181

(51) Int. Cl. H01M 4/04; H01M 10/0562; H01M 4/58; H01M 4/38

(52) U.S. Cl. CPC H01M 4/0471; H01M 4/38; H01M 4/58; H01M 10/0562

(57) ABSTRACT

Provided is a method of producing a sulfide solid electrolyte according to which an amount of residual elemental sulfur can be reduced with simple steps. The method of producing a sulfide solid electrolyte comprises: loading raw material for electrolytes, and elemental sulfur into a vessel, the raw material containing at least Li₂S and P₂S₅; and after said loading, amorphizing a raw material composition consisting of the raw material for electrolytes and the elemental sulfur, and synthesizing material for sulfide solid electrolyte; and after said amorphizing, heat-treating the material for sulfide solid electrolytes under an inert atmosphere at a temperature no less than a melting point of the elemental sulfur.

### FIELD

The present application discloses a method of producing a sulfide solid electrolyte.

### BACKGROUND

Metal-ion secondary batteries that have solid electrolyte layers using flame-retardant solid electrolytes (for example, a lithium-ion secondary battery and the like. Hereinafter referred to as “all-solid-state batteries”.) have an advantage of making it easy to simplify systems for securing safety.

Sulfide solid electrolytes of high Li-ion conductivity are known as solid electrolytes used for all-solid-state batteries. Examples of sulfide solid electrolytes include Li₂S—P₂S₅ based electrolytes, Li₂S—P₂S₅—LiBr—LiI based electrolytes that are Li₂S—P₂S₅ based electrolytes to which LiBr and LiI are added, and Li₂S—P₂S₅ based glass ceramics and Li₂S—P₂S₅—LiBr—LiI based glass ceramics which are glass ceramics thereof.

A problem with sulfide solid electrolytes is that elemental sulfur (hereinafter may be simply referred to as “elemental S”) is easy to mix therein as an impurity. The following (1) to (4) are considered to be factors in elemental S mixing in sulfide solid electrolytes:

(1) P₂S₅ that is used as raw material for sulfide solid electrolytes deteriorates when stored, and part of P₂S changes to an impurity (P₄S₉, P₄S₇, etc.). This impurity has a composition of a lower proportion of S atoms than P₂S₅, and thus elemental S forms as a by-product;

(2) if elemental S is encompassed in P₂S₅ of raw material according to (1), this elemental S cannot be in contact with other kinds of raw material, which makes its reactivity low, and many residues are left even after electrolytes are synthesized;

(3) elemental S forms while sulfide solid electrolytes are synthesized; and

(4) S—S bonds form, to form elemental S in a heat-treating step for making sulfide solid electrolytes, glass ceramics.

For example, Patent Literature 1 discloses a method of reducing an amount of a residual elemental sulfur component by washing a sulfide-based solid electrolyte with an organic solvent as a technique of reducing an elemental sulfur component existing in a sulfide solid electrolyte.

### CITATION LIST

### Patent Literature

Patent Literature 1: JP2016-006798A

### SUMMARY

### Technical Problem

The method of Patent Literature 1 requires the steps of adding and removing the organic solvent. These steps are complicated.

Patent Literature 1 describes that an amount of a residual elemental sulfur component in the washed sulfide solid electrolyte is 1 wt. % or less. This amount of a residual elemental sulfur component is measured by: extracting a supernatant of the organic solvent with which the sulfide solid electrolyte was washed, and quantitating a further supernatant that is obtained by filtering the extracted supernatant through a Millipore filter, using gas chromatography. Thus, some elemental S component that cannot be caught by the organic solvent and is left in the sulfide solid electrolyte, or some elemental S component that is failed to be caught when the supernatant is extracted might not be able to be counted. Therefore, an actual amount of a residual elemental S component in the sulfide solid electrolyte is estimated to be more than the measurement amount of Patent Literature 1.

An object of this disclosure is to provide a method of producing a sulfide solid electrolyte according to which an amount of residual elemental sulfur can be reduced with simple steps.

### Solution to Problem

As a result of his intensive studies, the inventor of the present application has found that an amount of residual elemental sulfur in a sulfide solid electrolyte can be reduced by loading elemental S along with raw material for electrolytes into a vessel, to synthesize material for sulfide solid electrolytes, and heat-treating the material for sulfide solid electrolytes at a temperature equal to or higher than the melting point of elemental sulfur.

In order to solve the above problems, the present disclosure takes the following means. That is:

the present disclosure is a method of producing a sulfide solid electrolyte, the method comprising: loading raw material for electrolytes, and elemental sulfur into a vessel, the raw material containing at least Li₂S and P₂S₅; and after said loading, amorphizing a mixture of the raw material for electrolytes and the elemental sulfur, and synthesizing material for sulfide solid electrolyte; and after said amorphizing, heat-treating the material for sulfide solid electrolytes under an inert atmosphere at a temperature no less than a melting point of the elemental sulfur.

In said loading comprised in the method of the present disclosure, preferably, 0.5 to 5 atm % of the elemental sulfur is loaded per 100 atm % of the raw material for electrolytes.

In said heat-treating comprised in the method of the present disclosure, preferably, the material for sulfide solid electrolytes is heat-treated at a temperature no less than a crystallization temperature of the material for sulfide solid electrolytes, to obtain the sulfide solid electrolyte, which is glass ceramics.

### Advantageous Effects

According to the present disclosure, a method of producing a sulfide solid electrolyte with which an amount of residual elemental sulfur can be reduced by simple steps can be provided.

### BRIEF DESCRIPTION OF DRAWINGS

FIG. 1 is a schematic view of one embodiment of the producing method of this disclosure;

FIG. 2 shows influence on amounts of residual elemental S in produced sulfide solid electrolytes according to amounts of elemental S loaded in the loading step in the examples 1 to 4 and comparative example 1; and

FIG. 3 shows influence on capacity retention of batteries that were produced using the sulfide solid electrolytes produced in the examples 1 to 4 and comparative example 1 according to the amounts of residual element S in these sulfide solid electrolytes.

### DETAILED DESCRIPTION OF EMBODIMENTS

Hereinafter the present disclosure will be described. The embodiments below are examples of this disclosure, and this disclosure is not restricted to the following embodiments. Expression “A to B” concerning numeral values A and B means “no less than A and no more than B” unless otherwise specified. In such expression, if a unit is added only to the numeral value B, the same unit is applied to the numeral value A as well.

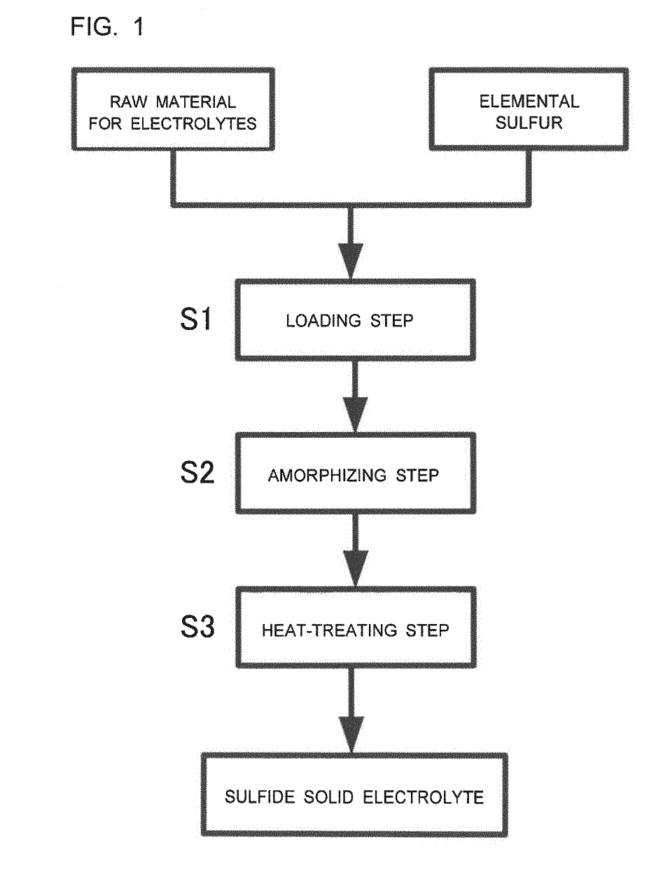

FIG. 1 is a schematic view of one embodiment of the producing method of this disclosure. In the producing method shown in FIG. 1, a loading step (S1), an amorphizing step (S2) and a heat-treating step (S3) lead to a sulfide solid electrolyte being produced, using raw material for electrolytes and elemental sulfur as starting material.

Hereinafter, the steps included in the producing method of the present disclosure will be described.

1. Loading Step (S1)

The loading step (hereinafter may be referred to as “S1”) is a step of loading raw material for electrolytes, and elemental sulfur into a vessel, the raw material containing at least Li₂S and P₂S₅. S1 only needs to be a step of loading at least raw material for electrolytes and elemental sulfur described below, into a vessel. S1 may be a step of loading, for example, liquid as used in a wet mechanical milling method, along with raw material for electrolytes and elemental sulfur, into a vessel. Examples of liquid that can be used in a wet mechanical milling method include alkanes such as heptane, hexane, and octane, and aromatic hydrocarbons such as benzene, toluene, and xylen.

(Raw Material for Electrolytes)

Raw material for electrolytes used in this disclosure contains at least Li₂S and P₂S₅. The raw material for electrolytes may contain only Li₂S and P₂S₅, and may contain other components in addition to Li₂S and P₂S₅. Examples of the other components include sulfides such as SiS₂, GeS₂, B₂S₃, and Al₂S₃, and LiX (X is a halogen) described later.

The proportion of Li₂S to the sum of Li₂S and P₂S₅ in the raw material for electrolytes is not restricted. For example, the proportion is preferably within the range of 70 mol % to 80 mol %, more preferably within the range of 72 mol % to 78 mol %, and further preferably within the range of 74 mol % to 76 mol %. This is because the sulfide solid electrolyte having an ortho composition or a composition close thereto, which has high chemical stability, can be obtained. Here, “ortho” generally means an oxoacid of the highest degree of hydration in oxoacids that can be obtained by hydrating one oxide. In the present disclosure, a crystal composition of a sulfide to which Li₂S is added most is called an ortho composition. In Li₂S—P₂S₅ based electrolytes, Li₃PS₄ falls under an ortho composition. In the case of a Li₂S—P₂S₅ based sulfide solid electrolyte, the proportion of Li₂S and P₂S₅ to obtain an ortho composition is Li₂S:P₂S₅=75:25 on a molar basis.

Preferably, the raw material for electrolytes further contains LiX (X is a halogen) in view of obtaining the sulfide solid electrolyte of high Li-ion conductivity. This is because the sulfide solid electrolyte of high Li-ion conductivity can be obtained. Specifically, X can be F, Cl, Br or I. Among them, Br or I is preferable. The proportion of LiX contained in the raw material for electrolytes is not restricted. For example, the proportion is preferably within the range of 1 mol % to 60 mol %, more preferably within the range of 5 mol % to 50 mol %, and further preferably within the range of 10 mol % to mol %.

(Elemental Sulfur)

Elemental sulfur used in this disclosure is not restricted as long as having a melting point. There exist no less than 30 allotropes of elemental sulfur. Generally, cyclo-S₈ is used as elemental sulfur having a melting point. There exist 3 crystal shapes of S₈, which are α-sulfur (orthorhombic sulfur, melting point: 112.8° C.), β-sulfur (monoclinic sulfur, melting point: 119.6° C.) and γ-sulfur (monoclinic sulfur, 106.8° C.). Preferably, α-sulfur (orthorhombic sulfur), which is stable at room temperature, is used in view of availability, handleability and so on. One allotrope may be used individually, and two or more allotropes may be used in combination as the elemental sulfur used in the present disclosure.

An amount of loading the elemental sulfur in S1 is preferably 0.5 to 10 atm %, and more preferably 0.5 to 5 atm %, per 100 atm % of the above described raw material for electrolytes. If this loading amount per 100 atm % of the raw material for electrolytes is 0.5 to 10 atm %, an amount of residual elemental S in the sulfide solid electrolyte can be reduced, and if it is 0.5 to 5 atm %, the amount of residual elemental S in the sulfide solid electrolyte can be reduced, and capacity retention of a battery using the sulfide solid electrolyte can be improved.

2. Amorphizing Step (S2)

The amorphizing step (hereinafter may be referred to as “S2”) is a step of amorphizing a mixture of the raw material for electrolytes and the elemental sulfur (hereinafter may be simply referred to as “mixture”), and synthesizing material for sulfide solid electrolyte after S0. This mixture can be obtained by the components of the material for electrolytes and the elemental sulfur partially mixing at the stage where they are loaded into the vessel in S1. A mixture of the raw material for electrolytes and the elemental sulfur, whole of which is mixed therein, can be obtained as well by application of mechanical energy, thermal energy or the like necessary for amorphizing in S2 as described later.

A method of amorphizing the mixture is not restricted. Examples of the method include mechanical milling (wet and dry) methods, and melt extraction. Among them, mechanical milling methods are preferable in view of easy reduction in manufacturing costs because of processability at room temperature, and the like. Further, a wet mechanical milling method is preferable in view of prevention of the mixture from fixing to the wall surface of the vessel etc. and easy obtainment of the highly amorphous material for sulfide solid electrolytes. A wet mechanical milling method can be carried out by loading liquid along with the raw material for electrolytes and the elemental sulfur into the vessel of a ball mill or the like. An advantage of a mechanical milling method is that the material for sulfide solid electrolytes having a target composition can be easily and simply synthesized while melt extraction has restrictions on a reaction environment and a reaction vessel.

A way of carrying out a mechanical milling method is not restricted as long as the mixture is amorphized while mechanical energy is applied thereto according to this method. Examples of a way of carrying out this method include using a ball mill, a vibrating mill, a turbo mill, a mechanofusion and a disk mill. Among them, a ball mill is preferably used, and a planetary ball mill is especially preferably used. This is because the desired material for sulfide solid electrolytes can be efficiently obtained.

Various conditions for a mechanical milling method are set such that the mixture can be amorphized and the material for sulfide solid electrolytes can be obtained. For example, in the case of using a planetary ball mill, the raw material for electrolytes, the elemental sulfur, and grinding balls are added to the vessel, and a process is carried out at a predetermined revolution speed for predetermined hours. In general, the higher the revolution speed is, the higher the speed at which the material for sulfide solid electrolytes forms; and the longer the processing time is, the higher the conversion ratio into the material for sulfide solid electrolytes is. A disk revolution speed when a planetary ball mill is used for carrying out the process is, for example, within the range of 200 rpm to 600 rpm, and preferably within the range of 250 rpm to 500 rpm. The processing time when a planetary ball mill is used for carrying out the process is, for example, within the range of 1 hour to 100 hours, and preferably within the range of 1 hour to 50 hours. Examples of material for the vessel and the grinding balls used in the ball mill include ZrO₂ and Al₂O₃. A diameter of each grinding ball is, for example, within the range of 1 mm to 20 mm.

3. Heat-Treating Step (S3)

The heat-treating step (hereinafter may be simply referred to as “S3”) is a step of heat-treating the material for sulfide solid electrolytes under an inert atmosphere at a temperature no less than a melting point of the elemental sulfur after S2.

In S3, the material for sulfide solid electrolytes is heat-treated at a temperature equal to or over the melting point of the elemental S, whereby most of the elemental S contained in the material for sulfide solid electrolytes is removed, and the amount of the residual elemental S in the sulfide solid electrolyte can be reduced more than before.

The inventor presumes that mechanisms therefor are the following (1) to (3):

(1) the elemental S that is loaded in S1 and excessively contained is molten by heat-treating the material for sulfide solid electrolytes at a temperature equal to or over the melting point of the elemental S, which leads to efflux of the elemental S on the surface of the material for sulfide solid electrolytes;

(2) liquid elemental S that is efflux on the surface of the material for sulfide solid electrolytes causes surface tension, to draw the elemental S exiting in the material for sulfide solid electrolytes and to gather the elemental S contained in the material for sulfide solid electrolyte on the surface of the material for sulfide solid electrolyte; and

(3) the liquid elemental S that is efflux on the surface of the material for sulfide solid electrolytes evaporates on the surface of the material for sulfide solid electrolytes, and is removed from the material for sulfide solid electrolyte.

The heat-treating in S3 is necessary to be carried out under an inert atmosphere. An inert gas constituting an inert atmosphere is not restricted. Examples of an inert gas include an Ar gas, a He gas and a N₂ gas. Heat-treating may be carried out with a gas flow or under a reduced pressure as long as an inert atmosphere can be maintained. When S3 is carried out in a closed system, the closed system preferably has a wide space spatially enough for pressure therein not to reach the saturated vapor pressure of the elemental sulfur because further evaporation of the elemental sulfur is blocked and an effect of removing the elemental sulfur might be insufficient if the elemental sulfur evaporates and the pressure therein reaches the saturated vapor pressure.

The heat-treating in S3 is necessary to be carried out at a temperature equal to or over the melting point of the elemental sulfur. Here, in the mode of using a plurality of allotropes that have different melting points in combination as the elemental sulfur in S1, “melting point of the elemental sulfur” means the melting point of an allotrope that has the highest melting point in a plurality of the allotropes that have different melting points.

In S3, the material for sulfide solid electrolytes is crystalized, and the sulfide solid electrolyte of glass ceramics can be obtained by heat-treating at a temperature equal to or over the melting point of the elemental sulfur, and equal to or over a crystallization temperature of the material for sulfide solid electrolytes. Generally, a crystallization temperature of material for sulfide solid electrolytes is higher than a melting point of elemental sulfur. Thus, in S3, the amorphous sulfide solid electrolyte can be obtained after S3 by heat-treating at a temperature equal to or over the melting point of the elemental sulfur, and lower than a crystallization temperature of the material for sulfide solid electrolytes, and the sulfide solid electrolyte of glass ceramics can be obtained by heat-treating at a temperature equal to or over a crystallization temperature of the material for sulfide solid electrolytes. Whether the sulfide solid electrolyte is glass ceramics or not can be confirmed by X-ray diffraction analysis, for example.

A crystallization temperature of the material for sulfide solid electrolytes can be determined by differential thermal analysis (DTA). A crystallization temperature of the material for sulfide solid electrolytes is different according to a composition of the material for sulfide solid electrolytes. For example, this temperature is within the range of 130° C. and 600° C.

The upper limit of the temperature in the heat-treating in S3 is not restricted. If the temperature in the heat-treating is too high, a crystalline phase of low Li-ion conductivity (called a low Li ion conductive phase) forms in the sulfide solid electrolyte of glass ceramics. Thus, heating is preferably carried out at a temperature lower than a formation temperature of a low Li ion conductive phase, which is different according to a composition of the material for sulfide solid electrolytes. For example, this temperature in the heat-treating only needs to be no more than 300° C. The formation temperature of a low Li ion conductive phase can be identified by X-ray diffraction measurement using CuKα lines.

Time for the heat-treating in S3 is not restricted as long as the amount of the residual elemental sulfur can be reduced for this time. For example, this time is preferably no less than 5 minutes and no more than 5 hours, and more preferably no less than 30 minutes and no more than 4 hours. A method of the heat-treating is not restricted. Examples of this method include a method of using a firing furnace.

In S3, the time for the heat-treating necessary for reducing the amount of the residual elemental S is time enough to amorphize the material for sulfide solid electrolytes. Thus, in S3, the sulfide solid electrolyte of glass ceramics can be obtained by heat-treating the material for sulfide solid electrolytes at a temperature equal to or over the crystallization temperature of the material for sulfide solid electrolytes.

According to this disclosure, the amount of the residual elemental S in the sulfide solid electrolyte can be reduced only by loading the elemental S along with the raw material for electrolytes when the material for sulfide solid electrolytes is synthesized, and heat-treating the obtained material for sulfide solid electrolytes. Thus, the amount of the residual elemental S can be reduced with the simple steps. In the present disclosure, if the sulfide solid electrolyte of glass ceramics is wanted to be obtained, the material for sulfide solid electrolytes can be crystalized at the same time as removal of the elemental S by heat-treating at a temperature equal to or over the crystallization temperature of the material for sulfide solid electrolytes in S3. Thus, it is not necessary to carry out a step of crystallizing the material for sulfide solid electrolytes separately. Therefore, the sulfide solid electrolyte of glass ceramics where the amount of the residual elemental sulfur is reduced can be produced with the extremely simple steps.

It is noted that the sulfide solid electrolyte of glass ceramics can be obtained by further carrying out heat-treating at a temperature equal to or over the crystallization temperature of the material for sulfide solid electrolytes after carrying out S3 at a temperature equal to or over the melting point of the elemental S, and lower than the crystallization temperature of the material for sulfide solid electrolytes. For example, a mode that a temperature of the heat-treating is changed in the middle of S3 can be like such a mode that the former half of S3 is carried out at a temperature equal to or over the melting point of the elemental sulfur, and lower than the crystallization temperature of the material for sulfide solid electrolytes, and the latter half thereof is carried out at a temperature equal to or over a temperature lower than the crystallization temperature of the material for sulfide solid electrolytes.

### EXAMPLES

[Synthesize Sulfide Solid Electrolyte]

### Example 1

(Raw Material)

The following were used as raw material for electrolytes: lithium sulfide (Li₂S, manufactured by Nippon Chemical Industries CO., LTD, 99.9% purity), phosphorus pentasulfide (P₂S₅, manufactured by Aldrich, 99.9% purity), lithium bromide (LiBr, manufactured by Kojundo Chemical Laboratory Co., Ltd., 99.9% purity) and lithium iodide (LiI, manufactured by Aldrich). As elemental sulfur, α-sulfur (S, manufactured by Wako Pure Chemical Industries, Ltd.) was used.

(Loading Step)

These raw material for electrolytes and elemental sulfur were weighed so as to have the molar ratio of Li₂S:P₂S₅:LiBr:LiI:S=56.25:18.75:15:10:0.5. Into a vessel of a planetary ball mill (45 ml, made from ZrO₂), the weighed raw material for electrolytes and elemental sulfur were loaded, dry heptane (water content: no more than 30 ppm, 4 g) was loaded, balls made from ZrO₂, having 5 mm in diameter were further loaded into the vessel, and the vessel was completely sealed hermetically.

(Amorphizing Step)

A raw material composite that consisted of the raw material for electrolytes and elemental sulfur was amorphized by mechanical milling at 290 rpm for 20 hours, and material for sulfide solid electrolytes (75(0.75Li₂S.0.25P₂S₅).15LiBr.10LiI.0.5S) was synthesized.

(Heat-Treating Step)

The material for sulfide solid electrolytes recovered from the vessel after the amorphizing step (75(0.75Li₂S.0.25P₂S₅).15LiBr.10LiI.0.5S) was heated under an Ar atmosphere at 210° C. for 3 hours, to remove heptane and to be glass ceramics, and a sulfide solid electrolyte according to the example 1 (75(0.75Li₂S.0.25P₂S₅).15LiBr.10LiI) was obtained.

### Example 2

A sulfide solid electrolyte according to the example 2 (75(0.75Li₂S.0.25P₂S₅).15LiBr.10LiI) was obtained in the same way as Example 1 except that an amount of the raw material was changed so that a composition in an electrolyte of the material for sulfide solid electrolytes was (75(0.75Li₂S.0.25P₂S₅).15LiBr.10LiI.1S).

### Example 3

A sulfide solid electrolyte according to the example 3 (75(0.75Li₂S.0.25P₂S₅).15LiBr.10LiI) was obtained in the same way as Example 1 except that the amount of the raw material was changed so that a composition in the electrolyte of the material for sulfide solid electrolytes was (75(0.75Li₂S.0.25P₂S₅).15LiBr.10LiI.1S).

### Example 4

A sulfide solid electrolyte according to the example 4 (75(0.75Li₂S.0.25P₂S₅).15LiBr.10LiI) was obtained in the same way as Example 1 except that the amount of the raw material was changed so that a composition in the electrolyte of the material for sulfide solid electrolytes was (75(0.75Li₂S.0.25P₂S₅).15LiBr.10LiI.10S).

### Comparative Example 1

A sulfide solid electrolyte according to the comparative example 1 (75(0.75Li₂S.0.25P₂S₅).15LiBr.10LiI) was obtained in the same way as Example 1 except that the amount of the raw material was changed so that a composition in the electrolyte of the material for sulfide solid electrolytes was (75(0.75Li₂S.0.25P₂S₅).15LiBr.10LiI), without loading the elemental sulfur.

[Producing Battery]

(Producing Cathode)

Cathode active material was coated with LiNb0₃ as a solid electrolyte in the atmosphere environment using a tumbling fluidized coating machine (manufactured by Powrex Corporation), and firing was carried out in the atmosphere environment, to cover the surface of the cathode active material with the solid electrolyte.

Into each vessel made from polypropylene (PP), a butyl butyrate solution composed of butyl butyrate and 5 mass % of a PVdF based binder (manufactured by Kureha Corporation), the above described cathode active material coated with the solid electrolyte, and the sulfide solid electrolyte made in the respective examples 1 to 4 and comparative example 1 (Li₂S—P₂S₅ based glass ceramics containing LiBr and Li) were added, VGCF™ (manufactured by Showa Denko K.K.) was added as conductive material, and the resultant was stirred with an ultrasonic dispersive device (UH-50 manufactured by SMT Corporation) for 30 seconds.

Next, each vessel was shaken with a mixer (TTM-1 manufactured by Sibata Scientific Technology Ltd.) for 3 minutes, and further stirred with the ultrasonic dispersive device for 30 seconds. After shaken with the mixer for 3 minutes, Al foil (manufactured by Nippon Foil Manufacturing) was coated with the resultant using an applicator according to a blade method. The coated electrode was air-dried. After that, the resultant was dried on a hot plate at 100° C. for 30 minutes, to obtain a cathode.

(Producing Anode)

Into each vessel made from PP, a butyl butyrate solution composed of butyl butyrate and 5 mass % of a PVdF based binder (manufactured by Kureha Corporation), natural graphite based carbon of 10 μm in average particle size (manufactured by Nippon Carbon Co., Ltd.) as anode active material, and the sulfide solid electrolyte made in the respective examples 1 to 4 and comparative example 1 (Li₂S—P₂S₅ based glass ceramics containing LiBr and LiI) were added, and the resultant was stirred in an ultrasonic dispersive device (manufactured by SMT Corporation) for 30 seconds.

Next, each vessel was shaken with a mixer (TTM-1 manufactured by Sibata Scientific Technology Ltd.) for 30 minutes. Cu foil (manufactured by Furukawa Electric Co., Ltd.) was coated with the resultant using an applicator according to a blade method. The coated electrode was air-dried. After that, the resultant was dried on a hot plate at 100° C. for 30 minutes, to obtain an anode.

(Producing Solid Electrolyte Layer)

Into a vessel made from PP, heptane solution composed of heptane and 5 mass % of a butadiene rubber (BR) based binder (manufactured by JSR Corporation), and the sulfide solid electrolyte made in the comparative example 1 (Li₂S—P₂S₅ based glass ceramics containing LiBr and LiI) were added, and the resultant was stirred in an ultrasonic dispersive device (UH-50 manufactured by SMT Corporation) for 30 seconds.

Next, the vessel was shaken with a mixer (TTM-1 manufactured by Sibata Scientific Technology Ltd.) for 30 minutes. After that, Al foil was coated with the resultant using an applicator according to a blade method. After coated, air-drying was carried out.

After that, the resultant was dried on a hot plate at 100° C. for 30 minutes, to obtain a solid electrolyte layer.

(Producing Sulfide all-Solid-State Battery)

The solid electrolyte layer was put into a mold of 1 m² to be pressed at 1 ton/cm² (≈98 MPa), the cathode was put into one side thereof to be pressed at 1 ton/cm² (≈98 MPa), and further the anode was put into the other side thereof to be pressed at 6 ton/cm² (=588 MPa), whereby a sulfide all-solid-state battery was obtained.

<Analysis of Amount of Residual Elemental S (TPD-MS Analysis)>

An amount of residual elemental S in the sulfide solid electrolyte produced in each example 1 to 4 and comparative example 1 was measured according to TPD-MS analysis. A device and measurement conditions used were as follows:

GC/MS QP5050A(4) manufactured by Shimadzu Corporation

heating rate: 10° C./min

temperature: 25 to 500° C.

dilute gas: He by 50 mL/min

<Measurement of Capacity Retention (Constant Current Constant Voltage (CCCV) Measurement)>

A process of detaching (releasing) lithium ions from the cathode was defined as “charging”, and a process of intercalating (occluding) lithium ions into the cathode was defined as “discharging”. A charge-discharge test was done using a charge-discharge testing device (TOSCAT series manufactured by Toyo System Co., Ltd.). Charge and discharge were repeated at ⅓ C in current flow at 25° C. in temperature within the range of 3 V (discharge) to 4.37 V (charge). Discharge capacity at the third cycle was regarded as initial capacity. After that, after the battery was stored for 28 days at 60° C. in temperature at 4.1 V in charge potential, discharge capacity after stored was measured in the same way as the initial capacity, and the ratio of the capacity after stored to the initial capacity was regarded as capacity retention.

(capacity retention)=(CC discharge capacity after stored)/(initial CC discharge capacity)×100(%)

[Result]

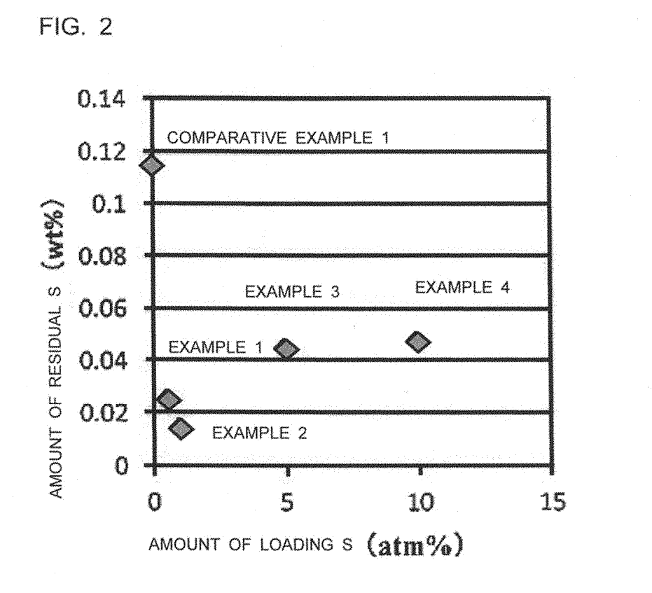

From FIG. 2, the amount of residual elemental S in the sulfide solid electrolyte according to each example 1 to 4, into which the raw material for electrolytes and the elemental sulfur were loaded in the loading step, was reduced more than that of the sulfide solid electrolyte according to the comparative example 1, into which the elemental sulfur was not loaded in the loading step.

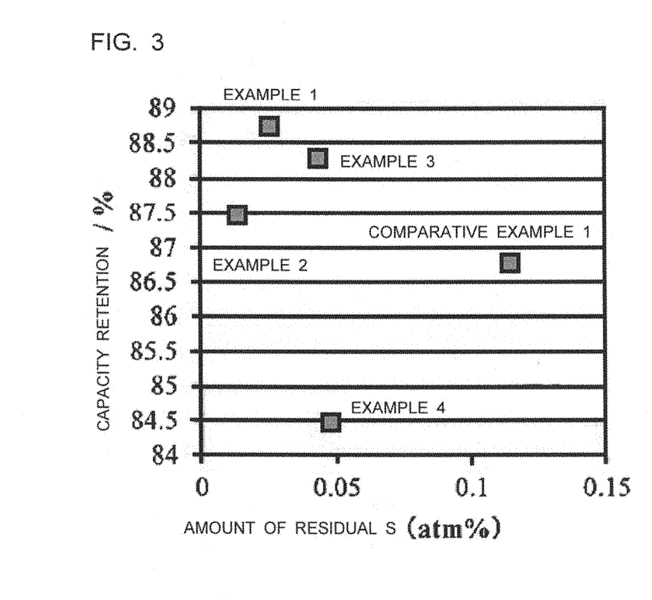

From FIG. 3, the capacity retention of the battery using the sulfide solid electrolyte according to each example 1 to 3, into which the 0.5 to 5 atm % of the elemental sulfur was loaded per 100 atm % of the raw material for electrolytes in the mixing step, was improved more than that of the battery using the sulfide solid electrolyte according to the comparative example 1, into which the elemental sulfur was not loaded in the mixing step. It is considered that the capacity retention of the battery using the sulfide solid electrolyte according to the comparative example 1 was lower than that of the battery using the sulfide solid electrolyte according to any of the examples 1 to 3 by the influence of the elemental sulfur that is an impurity. It is conjectured that in the battery using the sulfide solid electrolyte according to the example 4, into which 10 atm % of the elemental sulfur was loaded in the mixing step, the amount of loading the elemental sulfur was large and a composition of the sulfide solid electrolyte was changed, to decrease the capacity retention.

What is claimed is:

1. A method of producing a sulfide solid electrolyte, the method comprising:
loading raw material for electrolytes, and elemental sulfur into a vessel, the raw material containing at least Li₂S and P₂S₅; and
after said loading, amorphizing a mixture of the raw material for electrolytes and the elemental sulfur, and synthesizing material for sulfide solid electrolyte; and
after said amorphizing, heat-treating the material for sulfide solid electrolytes under an inert atmosphere at a temperature no less than a melting point of the elemental sulfur.

2. The method of producing a sulfide solid electrolyte according to claim 1, wherein
in said loading, 0.5 to 5 atm % of the elemental sulfur is loaded per 100 atm % of the raw material for electrolytes.

3. The method of producing a sulfide solid electrolyte according to claim 1, wherein
in said heat-treating, the material for sulfide solid electrolytes is heat-treated at a temperature no less than a crystallization temperature of the material for sulfide solid electrolytes, to obtain the sulfide solid electrolyte, which is glass ceramics.

4. The method of producing a sulfide solid electrolyte according to claim 2, wherein
in said heat-treating, the material for sulfide solid electrolytes is heat-treated at a temperature no less than a crystallization temperature of the material for sulfide solid electrolytes, to obtain the sulfide solid electrolyte, which is glass ceramics.
